(19) United States
(12) Patent Application Publication
(10) Pub. No.: US 2007/0264016 A1
(43) Pub. Date: Nov. 15, 2007

(54) Method and apparatus for rogue tolerant ranging and detection

(75) Inventor: David A. DeLew, Rohnert Park, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Petaluma, Inc., Naperville, IL (US)

(21) Appl. No.: 11/651,329

(22) Filed: Jan. 8, 2007

Related U.S. Application Data
(63) Continuation-in-part of application No. 11/515,504, filed on Sep. 1, 2006.
(60) Provisional application No. 60/793,748, filed on Apr. 21, 2006.
(60) Provisional application No. 60/848,955, filed on Oct. 3, 2006.

(51) Int. Cl. H04J 14/00

(52) U.S. Cl. 398/71

(57) ABSTRACT

A fault condition of a continuous stream of light up a shared fiber from an Optical Network Terminal (ONT) to an Optical Line Terminal (OLT) may adversely affect ranging of the ONT by the OLT. A method and corresponding apparatus for ranging an ONT tolerant to such a fault condition is disclosed. In an example embodiment, an optical receiver of an Optical Line Terminal (OLT) is reset at about a time a ranging signal from an ONT is expected to be received. Through the use of the example embodiment, an ONT can be ranged in the presence of a rogue ONT causing the fault condition. Moreover, the example embodiment enables the rogue ONT to be ranged in a presence of the fault condition and an Optical Distribution Network (ODN), which includes the OLT and the rogue ONT, to continue to support communications in a presence of the fault condition.

### RELATED APPLICATIONS

This application claims the benefit of Provisional Application No. 60/848,955, filed on Oct. 3, 2006, entitled “Method and Apparatus for Rogue Tolerant Ranging and Detection,” and is a continuation-in-part of U.S. application Ser. No. 11/515,504 entitled, “Methods and Apparatus for Identifying a Passive Optical Network Failure,” filed on Sep. 1, 2006, which claims the benefit of U.S. Provisional Application No. 60/793,748, filed on Apr. 21, 2006. The entire teachings of the above applications are incorporated herein by reference.

### BACKGROUND OF THE INVENTION

A Passive Optical Network (PON) can contain multiple Optical Line Terminals (OLTs), each connected by a shared optical fiber to a respective Optical Distribution Network (ODN) with multiple Optical Network Terminals (ONTs) on individual optical fibers. ONTs can malfunction and interfere with communications between the ONTs and the OLT on a shared optical fiber. Such malfunctions are generally the result of power outages or typical communication systems errors or failures. Other disruptions in communications can be caused by optical fibers being cut, such as by a backhoe. If ONTs are malfunctioning for any other reason, identifying the issue requires a technician to inspect each ONT, possibly causing costly interruptions to service.

### SUMMARY OF THE INVENTION

A method or corresponding apparatus for ranging an Optical Network Terminal (ONT) which is tolerant to a fault condition is provided in accordance with an embodiment of the present invention. An example embodiment includes resetting a receiver of an Optical Line Terminal (OLT) at about a time a ranging response from an ONT is expected to be received to tolerate a fault condition otherwise affecting ranging of the ONT.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example Passive Optical Network (PON) with a Central Office (CO) employing an Optical Line Terminal (OLT), in communication with multiple Optical Network Terminals (ONTs), employing embodiments of the present invention;

FIG. 2 is a block diagram of an example system to tolerate a fault condition otherwise affecting ranging of an ONT in accordance with an embodiment of the present invention;

FIG. 3 is a timing diagram illustrating an integrated no-input signal power level ramping over a ranging window;

FIG. 4 is a timing diagram illustrating resetting a receiver of an Optical Line Terminal (OLT) at about a time a ranging response from an Optical Network Terminal (ONT) is expected to be received in accordance with an embodiment of the present invention;

FIGS. 5A-5B are timing diagrams illustrating changing a time to reset a receiver of an OLT by adding and subtracting a delay in accordance with embodiments of the present invention;

FIG. 6 is a timing diagram illustrating changing a time to reset a receiver of an OLT by delaying for one or more delay increments in accordance with an embodiment of the present invention;

FIGS. 7A-7B are timing diagrams illustrating incrementing a time to reset a receiver of an OLT with each successive ranging attempt in accordance to an embodiment of the present invention;

FIG. 8 is a timing diagram illustrating incrementing a time to reset a receiver of an OLT through a range of delay increments in accordance with an embodiment of the present invention;

FIG. 9 is a flow chart of an example process ranging an ONT in accordance with an embodiment of the present invention; and

FIG. 10 is a flow chart of an example process identifying a fault condition in accordance with an embodiment of the present invention.

### DETAILED DESCRIPTION OF THE INVENTION

A description of example embodiments of the invention follows.

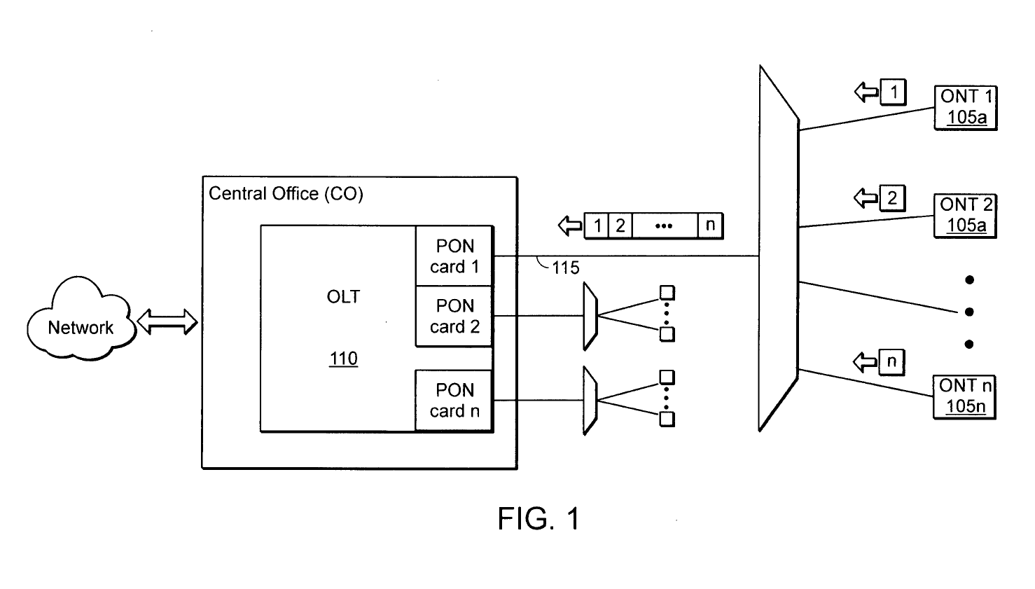

FIG. 1 illustrates an example Optical Distribution Network (ODN) 100, such as Passive Optical Network (PON), in which multiple Optical Network Terminals (ONTs) 105a-n transmit data to an Optical Line Terminal (OLT) 110 using a common optical wavelength and fiber optic media 115. A malfunctioning ONT (also referred herein as a rogue ONT) such as the ONT 105a can send a signal up to the OLT at inappropriate times, resulting in the OLT 110 not being able to communicate with any of the ONTs (e.g., 105b-n on the ODN 100). A typical PON protocol provides some functionality for detecting this problem, however, in a limited way, usually related to inappropriate modulated signals. Two ONT malfunctions that are not currently detected are:

1. An occurrence of an ONT sending a continuous light signal (modulated or un-modulated) up a fiber prior to an OLT attempting to establish communications with any ONTs on the ODN.

2. An occurrence of an ONT sending an un-modulated light signal up the fiber to an OLT at an inappropriate time while attempting to establish communications or after having established communications with any ONTs on the ODN.

During standard ranging, a receiver (not shown) of an OLT is reset at a time that corresponds to a closest distance the ONT can be from the OLT (e.g., a time corresponding to a real distance of 1 kilometer (km) or an “ideal” distance of Okm). In contrast, when using a rogue tolerant ranging method according to an embodiment of the present invention, resetting of the receiver of the OLT is delayed by a time delay, such as an equalization delay (Te) stored for each ONT. In this way, resetting of the receiver is delayed (e.g., by delaying when a reset signal is sent) until just before a ranging response from the ONT is expected to be received. In other words, a time to reset a receiver of an OLT may be delayed until just before a ranging response from an ONT is expected to be received.

The time to reset the receiver of the OLT may be based on a previous successful ranging attempt, presumably before a rogue ONT was added to the ODN. Such a time may be incremented in an iterative manner, for example, from minus 20 bit-times to plus 20 bit-times before or after the time to allow for variations. Each bit-time may be, for example, 6 nanoseconds at 155 Megahertz (MHz). In other words, a time to reset a receiver may be changed to allow correct communication to an ONT when a rogue ONT is also present on the ODN.

When standard ranging fails to establish communication with an ONT, the rogue tolerant ranging method according to an embodiment of the present invention may be used. If the rogue tolerant ranging method succeeds (i.e., an ONT is successfully ranged), this indicates to an operator that one or more rogue ONTs are present and affecting the ODN. Such rogue ONTs can be identified and removed at a later time without further loss of service to other ONTs on the ODN. The rogue tolerant ranging method allows all ONTs on the ODN, including a rogue ONT, to communicate with the OLT, even in the presence of the rogue ONT.

The rogue tolerant ranging method, unlike existing error detection techniques (e.g., those described in the various PON protocols), detects and identifies the aforementioned rogue ONT malfunctions. Moreover, no specialized test equipment is used to overcome these malfunctions; the OLT can be configured in hardware, software, or combination thereof, to test and adjust for the rogue ONT(s).

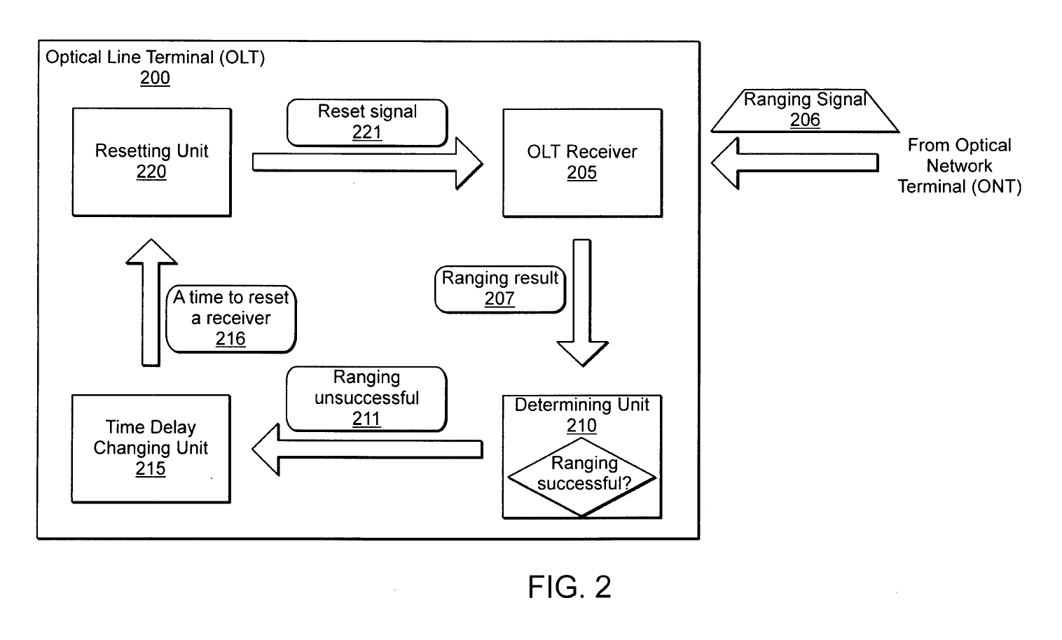

FIG. 2 illustrates an example Optical Line Terminal (OLT) 200 to tolerate a fault condition otherwise affecting ranging of an ONT. The OLT 200 includes an OLT receiver 205, determining unit 210, time delay changing unit 215, and resetting unit 220. At about a time the OLT receiver 205 is expected to receive a ranging signal 206 (e.g., a ranging response) from an ONT being ranged (not shown) the OLT receiver 205 is reset by the resetting unit 220. In one embodiment, the time the OLT receiver 205 is reset by the resetting unit 220 is based on an equalization delay assigned to the ONT previously. In another embodiment, the time the OLT receiver 205 is reset by the resetting unit 220 is based on a time previously determined by a successful ranging attempt.

Whether a ranging attempt is successful is determined by the determining unit 210. The determining unit 210 determines whether ranging is successful by, for example, measuring a no-input signal power level on a communications pathway.

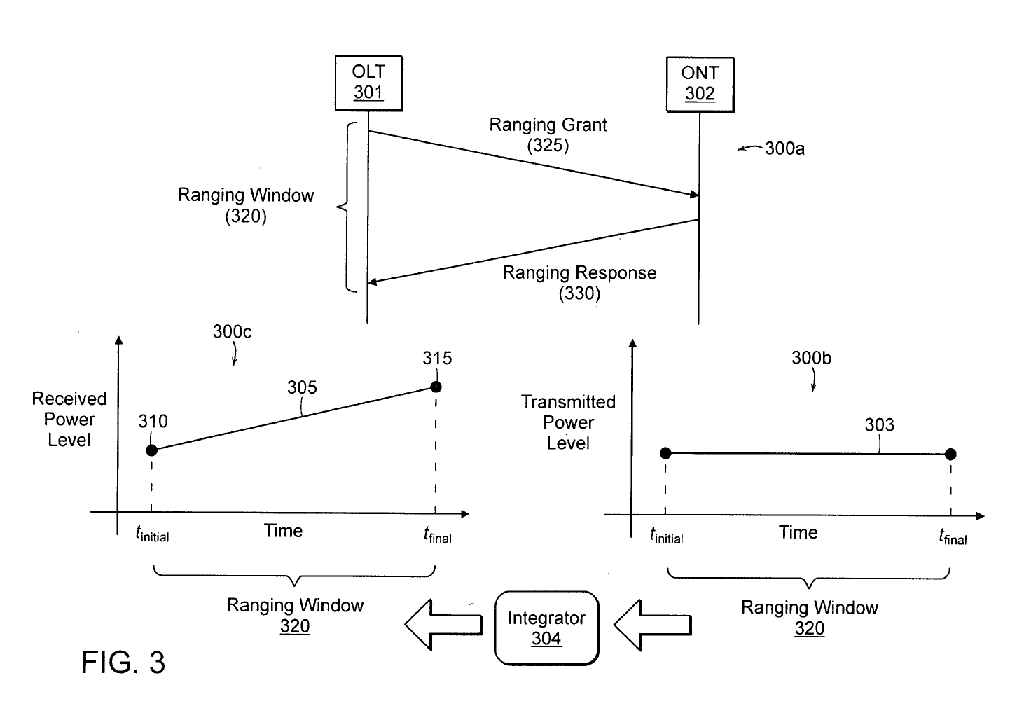

FIG. 3 is a diagram illustrating how a transmitted optical power level on a communications pathway from a faulty ONT affects whether an ONT is successful ranged by an OLT. A message diagram 300a illustrates an exchange of ranging signals or otherwise messages (e.g., a ranging grant (or ranging request) and a ranging response (or ranging cell)) between an OLT 301 and an ONT 302 during a ranging window 320. A transmitted power level versus time plot 300b illustrates the ONT 302 transmitting a no-input signal power level 303 during the ranging window 320. The no-input signal power level 303 may be, for example, a power level of a rogue ONT or power levels of non-transmitting ONTs. A received power level versus time plot 300c illustrates the OLT 301 receiving the no-input signal power level 303, which has been integrated by an integrator 304 in a receiver (not shown) of the OLT 304, as an integrated no-input signal power level 305.

The transmitted power level versus time plot 300b indicates that the no-input signal power level 303 may be constant during the ranging window 320, where the constant level may be a normal low level (e.g., −40 dBm) or a faulty high level (e.g., between −30 dBm and −25 dBm, or higher). The integrated no-input signal power level 305 ramps up from an integrated no-input signal power level at time tᵢₙᵢₜᵢₐₗ 3310 to an integrated no-input signal power level at time t_{final} 315, over the ranging window 320.

In operation, while the no-input signal power level 303 is being integrated over the ranging window 320, the OLT 301 sends a ranging grant 325 to the ONT 302. The ONT 302, in turn, responds with a ranging response 330. The OLT 301, having sent the ranging grant 325, receives the ranging response 330 from the ONT 302 during the ranging window 320 or it reports a ranging error.

Typically, the receiver of the OLT 301 is reset between adjacent upstream timeslots to accommodate power levels which vary from ONT to ONT. During ONT ranging, however, an upstream timeslot is effectively enlarged to accommodate variability in supported fiber lengths, i.e., more than one upstream timeslot is used for the ranging window 320. For example, the ONT 302 may be located up to 20 kilometers away from the OLT 301. To accommodate this distance, the duration of the ranging window 320 is set sufficiently long enough to allow the ONT 302 located 20 kilometers away from the OLT 301 to receive the ranging grant 325 and the OLT 301 to receive the ranging response 330.

When the duration of the ranging window 320 is set for a long period of time, the receiver of the OLT 301 is not reset during this period of time. As a result, a no-input signal power level, such as power level of rogue ONT on the ODN, have more time to be integrated by the receiver of the OLT 301, thus increasing the integrated no-input signal power level 305.

As the received power level versus time plot 300c illustrates, integrating the no-input signal power 303 over a long period of time causes the integrated no-input signal power level 305 to ramp (or increase). Consequently, over time, it may be more difficult to distinguish a zero-bit input signal (i.e., a zero bit) from a one-bit input signal (i.e., a one bit) possibly causing ranging errors and/or may lead to upstream communications problem(s)

Rather than using a typical ranging window, such as the ranging window 320, to determine when to reset a receiver of an OLT, in one embodiment of the present invention, the receiver is reset at about a time a ranging response from an ONT is expected to be received. Changing the time the receiver is reset may be referred to as a “dynamic reset.” Through the use of the dynamic reset, the amount of time a power level of rogue ONT is integrated may be limited, thereby reducing the adverse effects associated with integrating such a power level. In this way, the ranging techniques according to this and other embodiments of the present invention tolerate a fault condition otherwise affecting ranging of an ONT.

In some instances, however, resetting a receiver at about a time a ranging response from an ONT is expected to be received by an OLT does not result in successful ranging of the ONT. For example, a time between a time a ranging response from an ONT is expected to be received by an OLT and a time a ranging response from an ONT is actually received is large, possibly in terms of a time window or relative to a sensitivity of a particular receiver with respect to an amount of power a rogue ONT adds to an optical fiber link. Consequently, despite resetting the receiver at about the time the ranging response from the ONT is expected to be received, a power level is integrated sufficiently long enough to affect ONT ranging adversely.

In another example, a time a ranging response from an ONT is actually received occurs before a time a ranging response from the ONT is expected to be received. Again, despite resetting the receiver at about the time the ranging response from the ONT is expected to be received, a power level is integrated sufficiently long enough to affect ONT ranging adversely. In such instances, a time to reset a receiver is changed (described later in greater detail).

Additional techniques for determining whether ranging is successful are described in a U.S. patent application Ser. No. 11/515,504, entitled, “Methods and Apparatus for Identifying a Passive Optical Network Failure,” filed on Sep. 1, 2006 and assigned to Tellabs Petaluma, Inc., which is hereby incorporated by reference in its entirety.

Returning to FIG. 2, in an event the determining unit 210 determines (e.g., via a ranging result 206) ranging is unsuccessful, the determining unit 210 communicates its results via a determination message 206 to the time delay changing unit 215. The time delay changing unit 215, in turn, changes the time to reset the receiver of the OLT, such as via a time to reset a receiver message 216.

In one embodiment, the time delay changing unit 215 is configured with an adder (not shown) adapted to add a delay to the time when a ranging response from an ONT is expected to be received by an OLT. In another embodiment, the time delay changing unit 215 is configured with a subtracter (not shown) adapted to subtract a delay from the time when a ranging response from an ONT is expected to be received by an OLT. In yet another embodiment, the time delay changing unit 215 is configured with an incrementer (not shown) adapted to increment a delay in an iterative manner within a range of delays to delay the time to reset the receiver of the OLT and to compensate for variations in an equalization delay due to physical conditions expected to be experienced by an optical distribution network. In this way, the time to reset the receiver of the OLT is changed by the delay.

At the time to reset the receiver on the OLT, the resetting unit 220 resets the OLT receiver 205, such as via a reset signal 221.

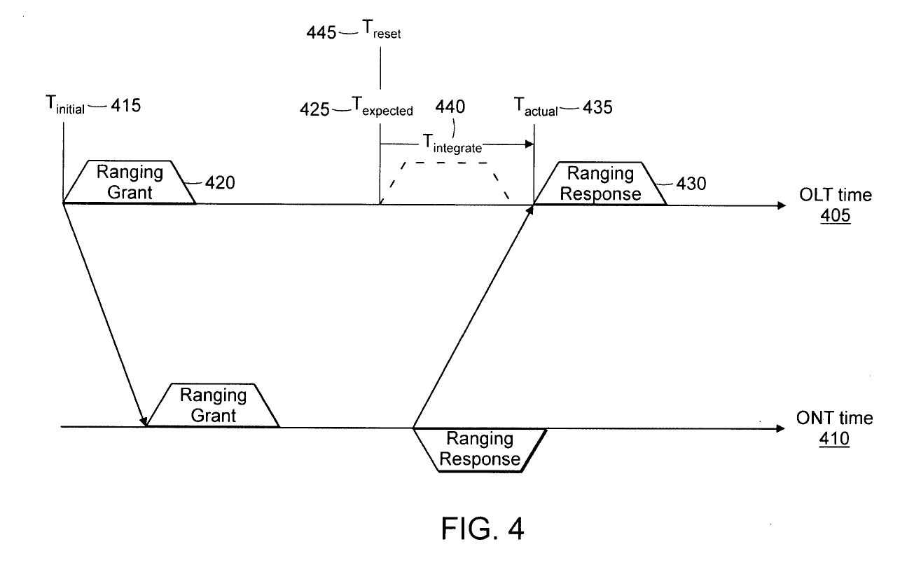

In FIG. 4, an Optical Line Terminal (OLT) (not shown) with an OLT time line 405 ranges an Optical Network Terminal (ONT) (not shown) with an ONT time line 410. At a time Tᵢₙᵢₜᵢₐₗ 415, the OLT sends a ranging grant 420 to the ONT. At a time T_{expected} 425, a ranging response 430 from the ONT is expected to be received by the OLT. In expectation, a receiver (not shown) of the OLT is reset at a time Tᵣₑₛₑₜ 445. In this example, the receiver is reset at about a time the ranging response 430 is expected to be received. That is, the time T_{expected} 425 and time Tᵣₑₛₑₜ 445 occur about the same time.

In one embodiment, a receiver is reset at a time Tᵣₑₛₑₜ and disabled at a time T_{disabled}. Between the time Tᵣₑₛₑₜ and the time T_{disabled} is an expected ranging response time T_{ranging} response, which is typically at least as long as a ranging response message or signal. Disabling the receiver at T_{disabled} limits the effects of post-integration by an integrator (not shown) which may interfere with ONT ranging and/or may lead to upstream communications problem(s).

In this example, rather than at the time T_{expected} 425, the OLT actually receives the ranging response 430 at a time T_{actual} 435. Between the time T_{expected} 425 and the time T_{actual} 435, in a typical optical receiver manner, the receiver of the OLT integrates a power level of a rogue ONT for a time T_{integrate} 440, which may extend further along the OLT time line 405 to an upper bound of a typical ranging window (e.g., a time equivalent to ranging an ONT 20 kilometers from the OLT). By not resetting the receiver of the OLT at the time Tᵢₙᵢₜᵢₐₗ 415, but at about the time T_{expected} 425 (e.g., at the time Tᵣₑₛₑₜ 445), in some embodiments, the amount of time the receiver integrates is limited or otherwise shortened to the time T_{integrate} 440.

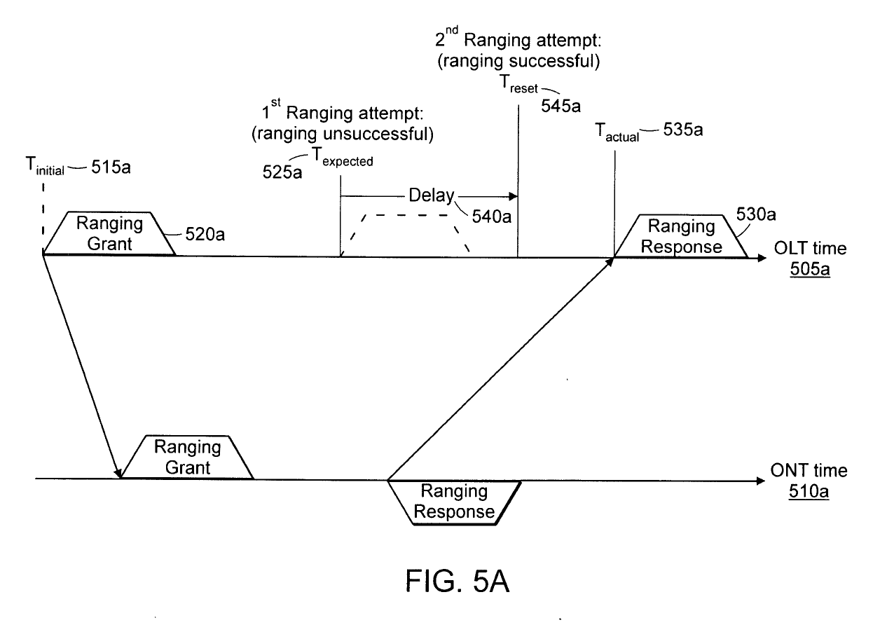

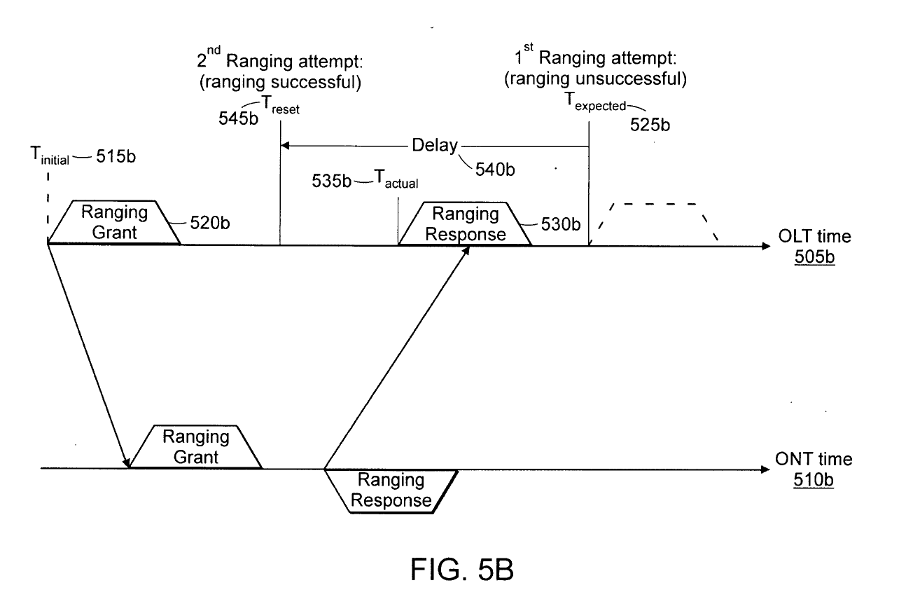

FIGS. 5A and 5B are timing diagrams illustrating changing a time to reset a receiver of an OLT in an event ONT ranging is unsuccessful.

In FIG. 5A, an OLT operating according to an OLT time line 505 ranges an ONT operating according to an ONT time line 510. At a time Tᵢₙᵢₜᵢₐₗ 515, the OLT sends a ranging grant 520 to the ONT. At a time T_{expected} 525, a ranging response 530 from the ONT is expected to be received by the OLT. In expectation, a receiver of the OLT is reset at about the time T_{expected} 525. Rather than at the time T_{expected} 525, the ranging response 530 is actually received by the OLT at a time Tactual 535.

In this example, despite resetting the receiver at about the time T_{expected} 525 in a first ranging attempt, ranging is unsuccessful. In a second ranging attempt, the time to reset the receiver is changed by adding a delay 540 to the time T_{expected} 525. With the delay 540 added, the receiver is reset at a time Tᵣₑₛₑₜ 545, and ranging is successful. With the ONT successfully ranged, the time Tᵣₑₛₑₜ 545 may be optionally stored. In others words, in an event ranging is successful, the time Tᵣₑₛₑₜ 545 is stored. As such, the receiver of the OLT in subsequent ranging attempts is not reset at the time T_{expected} 525, but at the time Tᵣₑₛₑₜ 545.

In an alternative embodiment, resetting a receiver of an OLT at about a time a ranging response is expected to be received is based on a time which resulted in a successful ranging attempt previously.

In FIG. 5B, an OLT operating according to an OLT time line 505b ranges an ONT operating according to an ONT time line 510b. At a time Tᵢₙᵢₜᵢₐₗ 515b, the OLT sends a ranging grant 520b to the ONT. At a time T_{expected} 525b, a ranging response 530b from the ONT is expected to be received by the OLT. In expectation, a receiver of the OLT is reset at about the time T_{expected} 525b. Rather than at the time T_{expected} 525b, the ranging response 530b is actually received by the OLT at a time T_{actual} 535b.

In this example, despite resetting the receiver at about the time T_{expected} 525b in a first ranging attempt, ranging is unsuccessful. In a second ranging attempt, the time to reset the receiver is changed by subtracting a delay 540b from the time T_{expected} 525b. With the delay 540b subtracted, the receiver is reset at a time Tᵣₑₛₑₜ 545b, and ranging is successful. With the ONT successfully ranged, the time Tᵣₑₛₑₜ 545b may be optionally stored. In others words, in an event ranging is successful, the time Tᵣₑₛₑₜ 545b is stored. As such, the receiver of the OLT in subsequent ranging attempts is not reset at the time T_{expected} 525b, but at the time Tᵣₑₛₑₜ 545b.

In an alternative embodiment, resetting a receiver of an OLT at about a time a ranging response is expected to be received is based on a time which resulted in a successful ranging attempt previously.

To ensure upstream communications sent from an ONT is received by the OLT in a correct time slot, relative to upstream communications from other ONTs, data is delayed at least for an equalization delay before being sent. Equalization delays are assigned to ONTs to equalize logical distances between the OLT and ONTs, making every ONT appear equidistant from the OLT. Since physical distances from the OLT vary from ONT to ONT, the equalization delays also vary from ONT to ONT.

Based on an equalization delay assigned to a given ONT, a time a ranging response from the given ONT is expected to be received can be calculated or otherwise determined. As such, resetting a receiver about the time the ranging response from the ONT is expected to be received may be based on the equalization delay for the given ONT.

However, an equalization delay for a given ONT varies, for example, as physical conditions experienced (or expected to be experienced) by an Optical Distribution Network (ODN) change. For example, temperature variations cause fiber optic cables to lengthen and shorten, effectively causing the ONT to be further away from or closer to an OLT in optical path distance. Accordingly, to ensure the OLT receives upstream communications in the correct time slot, an equalization delay for a given ONT may be updated with some periodicity. Consequently, a time a ranging response from an ONT is expected to be received by an OLT and a time a ranging response from an ONT is actually received by the OLT may differ throughout a day or from season to season. Generally speaking, to accommodate such variations, a time to reset a receiver of an OLT may be delayed (or advanced) in increments.

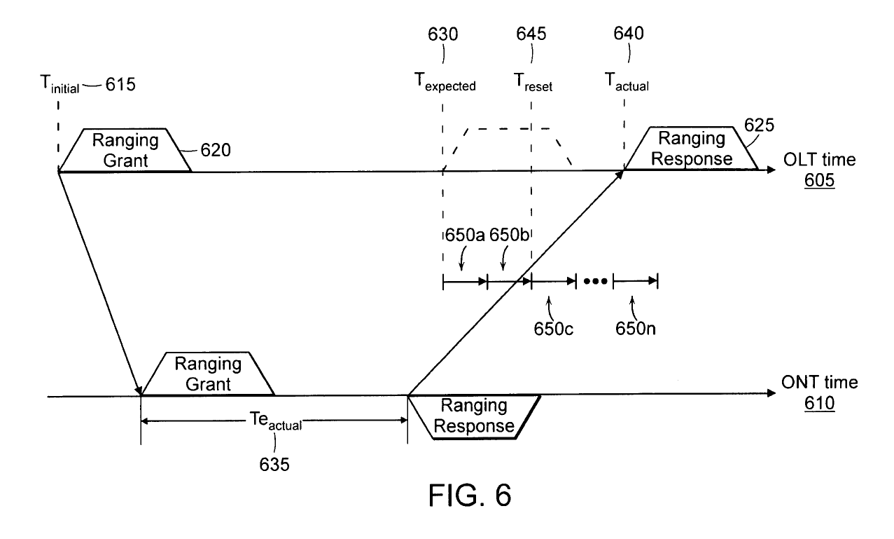

FIG. 6 illustrates an OLT operating according to an OLT time line 605 ranging an ONT operating according to an ONT time line 610. At a time Tᵢₙᵢₜᵢₐₗ 615, the OLT transmits a ranging grant 620 to the ONT. The OLT expects to receive a ranging response 625 from the ONT at about a time T_{expected} 630 based on an equalization delay (not shown) known for the ONT. Due to variations, however, the ONT transmits the ranging response after an equalization delay T_{actual} 635, which differs from the equalization delay known for the ONT. Consequently, the OLT receives the ranging response 625 not at the time T_{expected} 630, but rather at a time T_{actual} 640. To accommodate such variations in an equalization delay, a time to reset a receiver of the OLT is changed.

In FIG. 6, a time to reset a receiver of the ONT Tᵣₑₛₑₜ 645 is delayed for one or more delay increments 650a, 650b . . . 650n, generally 650a-n. In one embodiment, a size (or duration) of the delay increments 650 depends on a transmission rate and is measured in “bit times.” A “bit time” is an amount of time needed to eject one bit at a given rate of transmission. For example, transmitting at rate 155.52 Megabits per second (Mbps), one bit is ejected every 6 nanoseconds. Thus, at 155.52 Mbps, one bit time is equal to 6 nanoseconds per bit. As another example, at 1 Gigabits per second (Gbps), one bit time is equal to 1 nanoseconds per bit.

In another embodiment, a size (or duration) of the delay increments 650 depends on an overall system tolerance window. For example, the overall system tolerance window may be defined or otherwise configured to be plus or minus 100 nanoseconds. Accordingly, a duration of each delay increment is some portion of the plus or minus 100 nanoseconds.

Continuing to refer to FIG. 6, the time Tᵣₑₛₑₜ 645 (i.e., the time to reset the receiver) is delayed for two delay increments, viz., 650a and 650b. That is, from the time T_{expected} 630 (i.e., the time the ranging response is expected to be received), two delay increments elapse before resetting the receiver. In this example, the time Tᵣₑₛₑₜ 645 is delayed for whole number multiples of the delay increments 650. In another embodiment, a time to reset a receiver is delayed for something less than whole number multiples of delay increments, e.g., 1½ delay increments, 2¾ delay increments, and so forth.

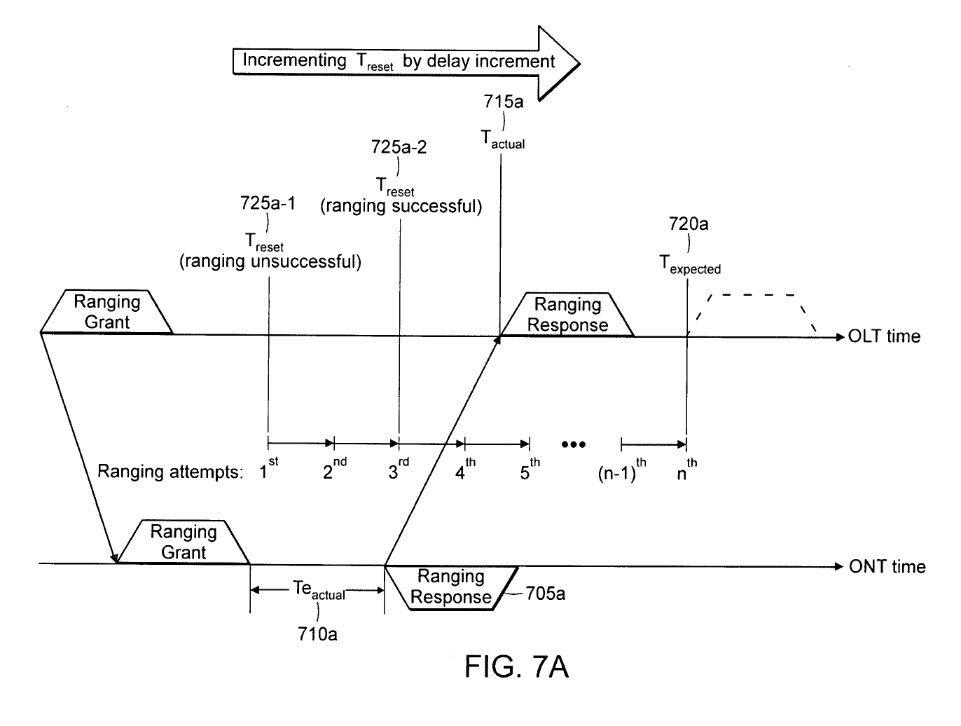

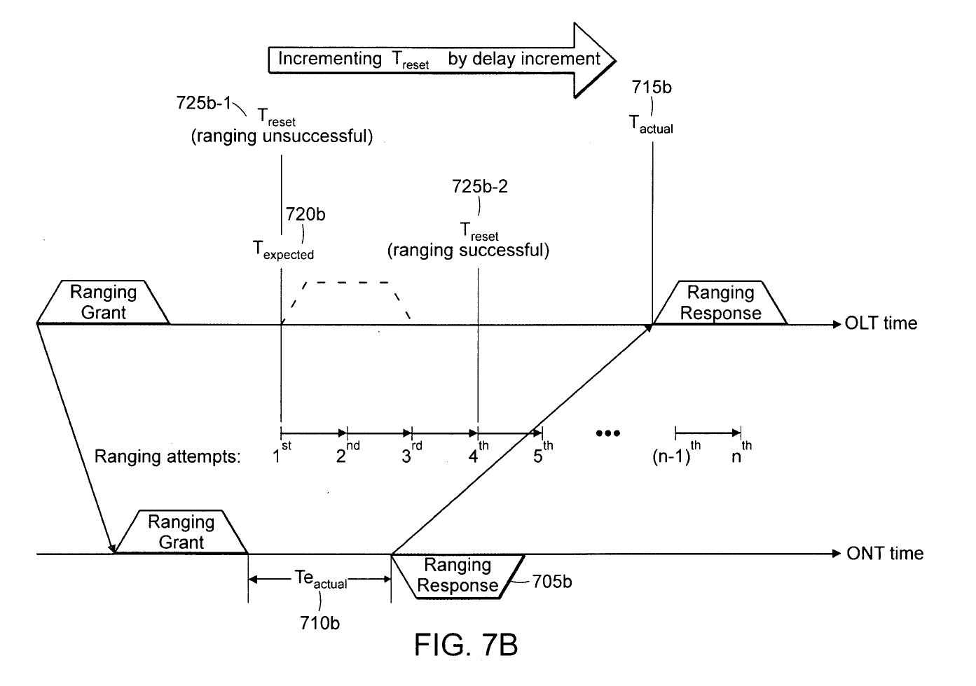

In FIG. 7A, due to a variation, transmitting a ranging response 705a is delayed for an actual equalization delay Te_{actual} 710a. Consequently, the ranging response 705a is actually received at a time T_{actual} 715a. Based on an equalization delay known to an OLT, however, the ranging response 705a is expected to be received at a time T_{expected} 720a. In this instance, the time T_{actual} 715a occurs in time before the time T_{expected} 720a.

In a first ranging attempt, resetting a receiver of the OLT is advanced by n number of delay increments from the time T_{expected} 720a, and the receiver is reset at a time Tᵣₑₛₑₜ 725a-1. In this example, the first ranging attempt is unsuccessful, i.e., the ranging the ONT is unsuccessful. In an event ranging is unsuccessful in a next ranging attempt, the time to reset the receiver of the OLT is incremented (i.e., a time at which the receiver of the OLT is reset is incremented).

In a second ranging attempt, a time at which the receiver of the OLT is reset is advanced (not shown) by n−1 number of delay increments from the time T_{expected} 720a. In this example, the second ranging attempt is unsuccessful. In a third ranging attempt, a time at which the receiver of the OLT is reset is advanced by n−2 delay increments from the time T_{expected} 720a and the receiver is reset at a time Tᵣₑₛₑₜ 725a-2. In this example, the third ranging attempt is successful.

In FIG. 7B, due to a variation, transmitting a ranging response 705b is delayed for an actual equalization delay Te_{actual} 710b. Consequently, the ranging response 705b is actually received by the OLT at a time T_{actual} 715b. Based on an equalization delay known to an OLT, however, the ranging response 705b is expected to be received at a time T_{expected} 720b. In this instance, the time Tactual 715b occurs after the time T_{expected} 720b.

In a first ranging attempt, resetting a receiver of the OLT is advanced by zero number of delay increments from the time T_{expected} 720b and the receiver is reset at a time Tᵣₑₛₑₜ 725b-1. In this example, the first ranging attempt is unsuccessful, i.e., the ranging the ONT is unsuccessful. In an event ranging is unsuccessful in a next ranging attempt the time to reset the receiver of the OLT is incremented.

In a second and a third ranging attempt, the time to reset the receiver of the OLT is advanced (not shown) by 1 and 2 number of delay increments from the time T_{expected} 720, respective. In this example, the second and the third ranging attempt are unsuccessful. In a fourth ranging attempt, the time to reset the receiver of the OLT is advanced by 3 delay increments from the time T_{expected} 720b and the receiver is reset at a time Tᵣₑₛₑₜ 725b-2. In this example, the fourth ranging attempt is successful. With the ONT successfully ranged, the time Tᵣₑₛₑₜ 725b-2 may be optionally stored. In others words, in an event ranging is successful, the time Tᵣₑₛₑₜ 725b-2 is stored. As such, the receiver of the OLT in subsequent ranging attempts is not reset at the time T_{expected} 720, but at the time Tᵣₑₛₑₜ 725b-2.

In an alternative embodiment, resetting a receiver of an OLT at about a time a ranging response is expected to be received is based on a time which resulted in a successful ranging attempt previously.

FIG. 7A illustrates in an event a ranging response is actually received before a time a ranging response is expected to be received (e.g., T_{expected} 720), a time to reset a receiver (e.g., Tᵣₑₛₑₜ 725-1) is iteratively incremented by advancing the time to reset a receiver by n number of delay increments from the time T_{expected}.

FIG. 7B illustrates in an event a time a ranging response is actually received after a time a ranging response is expected to be received (e.g., T_{expected} 720a), a time to reset a receiver (e.g., Tᵣₑₛₑₜ 725b-1) is iteratively incremented by delaying the time to reset a receiver by n number of delay increments from the time T_{expected}.

In contrast to FIGS. 7A and 7B, in an event a ranging response is actually received before or after a time a ranging response is expected to be received (T_{expected}), a time to reset a receiver (Tᵣₑₛₑₜ) is iteratively incremented by both advancing and delaying the time Tᵣₑₛₑₜ by n number of delay increments from the time T_{expected}.

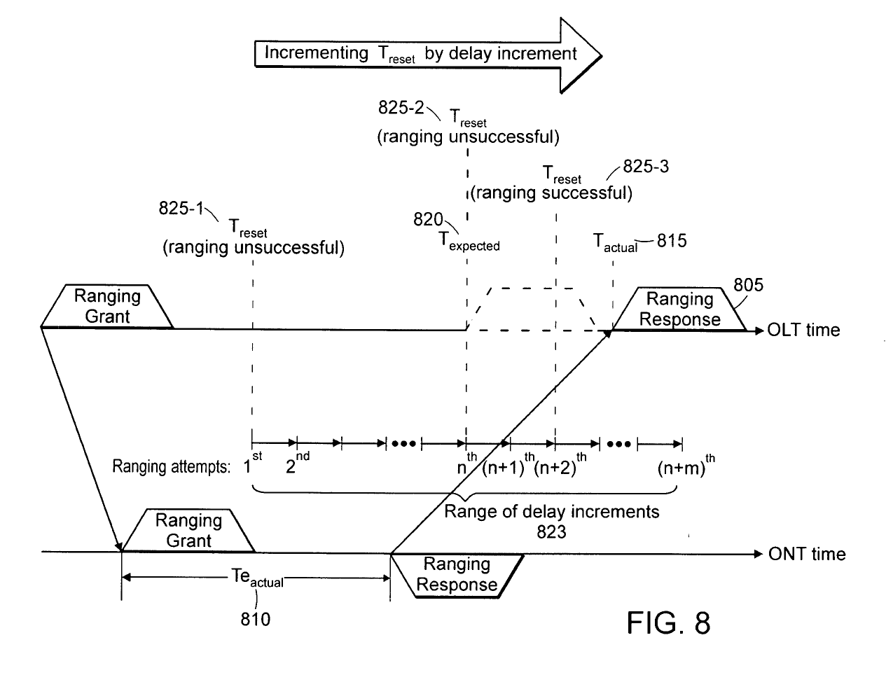

In FIG. 8, transmitting a ranging response 805 is delayed for an actual equalization delay Te_{actual} 810. Consequently, the ranging response 805 is actually received at a time T_{actual} 815. Based on a known equalization delay, however, the ranging response 805 is expected to be received at a time T_{expected} 820. To accommodate such variation a time to reset a receiver is changed by iteratively incrementing a delay with a range of delays.

For purposes of describing this and other embodiments, delay increments advancing a time to reset a receiver of an OLT (Tᵣₑₛₑₜ) so that that the time (Tᵣₑₛₑₜ) occurs in time before a time a ranging response from an ONT is expected to be received (T_{expected}) are referred to hereinafter as “negative” delay increments. Conversely, delay increments delaying a time to reset a receiver of an OLT (Tᵣₑₛₑₜ) so that the time Tᵣₑₛₑₜ occurs in time after the time T_{expected} are referred to hereinafter as “positive” delay increments. One skilled the art will readily acknowledge the choice of labels is arbitrary and is not intended to be limiting.

Continuing to refer to FIG. 8, a range of delay increments 823 includes n number of negative delay increments and m number of positive delay increments. In a first ranging attempt, the time to reset the receiver of the OLT is advanced by n number of negative delay increments from the time T_{expected} 820, and the receiver is reset at a time Tᵣₑₛₑₜ 825-1. In this example, the first ranging attempt is unsuccessful, i.e., ranging of the ONT is unsuccessful. In an event ranging is unsuccessful, in a next ranging attempt the time to reset the receiver of the OLT is changed by incrementing to a next delay increment within the range of delay increments 823.

In an n^{th} ranging attempt, the time to reset the receiver of the OLT is advanced by zero number of negative delay increments from the time T_{expected} 820, and the receiver is reset at a time Tᵣₑₛₑₜ 825-2. In this instance, resetting the receiver at about the time the ranging response is expected to be received does not result in successful ranging.

In (n+2)^{th} ranging attempt, the time to reset the receiver of the OLT is delayed by 2 positive delay increments from the time T_{expected} 820, and the receiver is reset at a time Tᵣₑₛₑₜ 825-3. In this example, the third ranging attempt is successful. With the ONT successfully ranged, the time Tᵣₑₛₑₜ 825-3 may be optionally stored. In others words, in an event ranging is successful, the time Tᵣₑₛₑₜ 825-3 is stored. As such, the receiver of the OLT in subsequent ranging attempts is not reset at the time T_{expected} 820, but at the time Tᵣₑₛₑₜ 825-3.

In an alternative embodiment, resetting a receiver of an OLT at about a time a ranging response is expected to be received is based on a time which resulted in a successful ranging attempt previously.

FIGS. 7A-7B and 8 illustrate changing a time to reset a receiver in a “forward” direction in time. For example in FIG. 7A, in a first ranging attempt, the time to reset the receiver is advanced by n number of delay increments, and the receiver is reset at the time Tᵣₑₛₑₜ 725-1. Then in a second ranging attempt, the time to reset the receiver of the OLT is advanced by n−1 number of delay increments, and the receiver is reset at the time Tᵣₑₛₑₜ 725-2. The time Tᵣₑₛₑₜ 725-1 occurs before the time Tᵣₑₛₑₜ 725-2. One skilled in the art, however, will readily recognize embodiments of the present invention are not limited to this example.

For example, in a first ranging attempt, a time to reset a receiver of an OLT is delayed by n number delay increments from a time a ranging response from an ONT is expected to be received (T_{expected}). In a second ranging attempt, resetting the receiver is delayed by n−1 number of delay increments from the time T_{expected}, and so on. With each successive ranging attempt, a time to reset a receiver (Tᵣₑₛₑₜ) occurs earlier in time. That is to say, a time to reset a receiver is changed in a “backwards” direction in time relative to the time T_{expected} in successive ranging attempts.

In another example, in a first ranging attempt, a time to reset a receiver of an OLT is delayed by n number of delay increments from a time a ranging response from an ONT is expected to be received (T_{expected}). In the case of n being equal to zero, the receiver is reset at about the time the ranging response from the ONT is expected to be received. In a second ranging attempt, resetting the receiver is delayed by n number of delay increments in one direction in time. In a third ranging attempt, resetting the receiver is delayed by n number of delay increments in the other direction in time, and so on. With each successive ranging attempt, a time to reset a receiver (Tᵣₑₛₑₜ) occurs either earlier or later in time. That is to say, a time to reset a receiver starts at a “middle time” and can be shifted relative to the middle time in either directions in time in successive ranging attempts.

In yet another example, in a first ranging attempt, a time to reset a receiver of an OLT is delayed by n delay increments from a time a ranging response from an ONT is expected to be received (T_{expected}). In a second ranging attempt, resetting the receiver is delayed by n/2 delay increments from the time T_{expected}, and so on. With each successive ranging attempt, a time to reset a receiver (Tᵣₑₛₑₜ) is halved.

In still another example, in a first ranging attempt, a time to reset a receiver of an OLT (Tᵣₑₛₑₜ) is delayed by any number of delay increments from a time a ranging response from an ONT is expected to be received (T_{expected}). In a second ranging attempt, the time Tᵣₑₛₑₜ is delayed by any number delay increments from the time T_{expected}, and so on. That is to say, the time to reset a receiver of an OLT is randomized.

In still yet another example, a time to reset a receiver of an OLT is delayed from a time a ranging response from an ONT is expected to be received (T_{expected}) by a delay which has been calculated or otherwise determined.

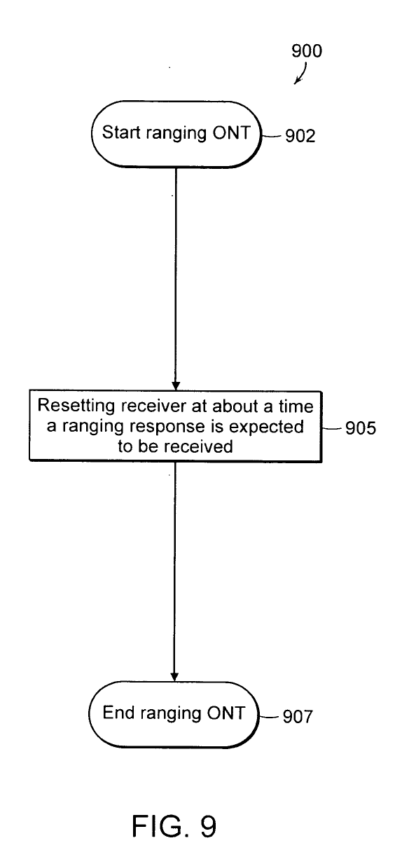

In FIG. 9, a flow diagram 900 illustrates ranging an ONT. Ranging the ONT starts (902). A receiver of an OLT is reset (905) at about a time a ranging response from the ONT is expected to be received. By doing so, a fault condition affecting ranging of the ONT is tolerated, and traffic and communications are uninterrupted by a rogue ONT. Ranging the ONT ends (902). The ONT is ranged.

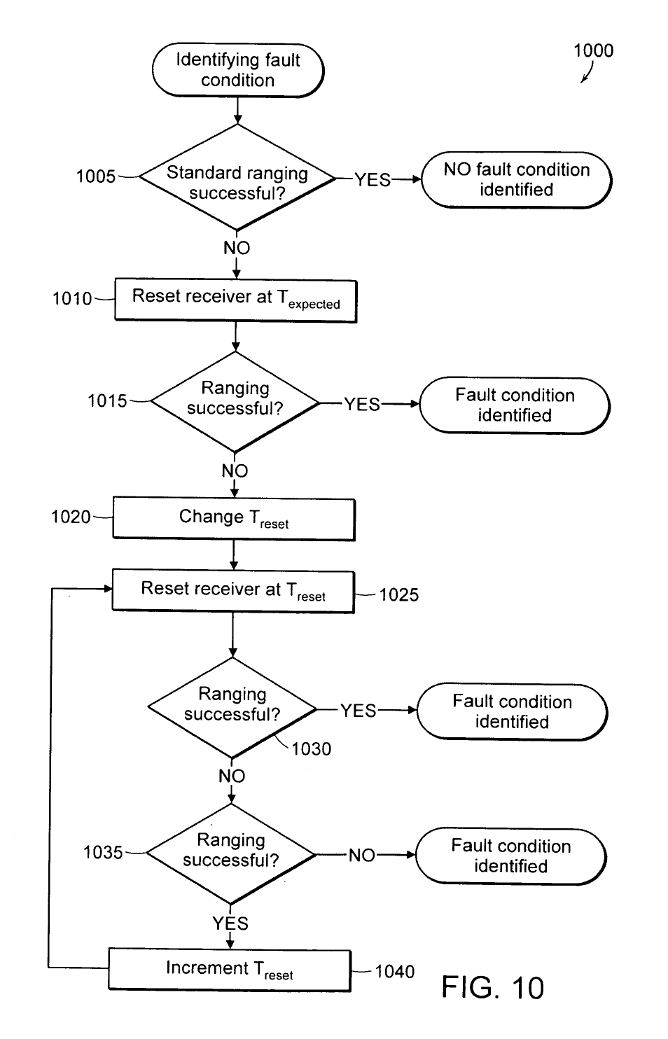

In FIG. 10, a flow diagram 1000 illustrates identifying a fault condition. A ranging attempt using a standard ranging window is determined (1005) successful or not. If determined (1005) successful, there is no fault condition to be identified, and the flow diagram 1000 ends. If determined (1005) unsuccessful, however, in a next ranging attempt, a receiver of an OLT is reset (1010) at a time a ranging response from an ONT is expected to be received (T_{expected}).

Whether the next ranging attempt is successful is determined (1015). If determined (1015) successful, a fault condition is identified and the flow diagram 1000 ends. If determined (1015) unsuccessful, however, in a next ranging attempt, a time to reset a receiver of an OLT (Tᵣₑₛₑₜ) is changed (1020). With the time Tᵣₑₛₑₜ changed (1020), the receiver of the OLT is reset (1025) at the time Tᵣₑₛₑₜ.

Whether the next ranging attempt is successful is determined (1030). If determined (1030) successful, a fault condition is identified and the flow diagram 1000 ends. If determined (1030) unsuccessful, however, the flow diagram further determines (1035) whether to continue changing the time Tᵣₑₛₑₜ.

Whether the flow diagram 1000 determines (1035) to continue changing the time Tᵣₑₛₑₜ may be limited by, for example, a number of instances configured or otherwise permitted. By way of example, the number of instances is limited to 20 and, as such, the time Tᵣₑₛₑₜ is changed (1020) 20 times before the time Tᵣₑₛₑₜ is no longer changed.

In another example, the time Tᵣₑₛₑₜ is changed (1020) until a range of times is tried or otherwise covered. By way of example, the time Tᵣₑₛₑₜ is changed (1020) by 1 to 100 nanoseconds. That is, the time Tᵣₑₛₑₜ is changed (1020) by 1 nanosecond in a first ranging attempt, by 2 nanoseconds in a second ranging attempt, and so forth. The time Tᵣₑₛₑₜ continues to change (1020) until the time Tᵣₑₛₑₜ is changed by 100 nanoseconds.

If the flow diagram 1000 determines (1035) not to continue changing the time Tᵣₑₛₑₜ, a fault condition is identified and the flow diagram 1000 ends. If however, the flow diagram 1000 determines (1035) to continue changing the time Tᵣₑₛₑₜ, the time Tᵣₑₛₑₜ is incremented (1040). The flow diagram 1000 continues and the receiver of the OLT is reset (1025) at the time Tᵣₑₛₑₜ.

Changing (1020) the time Tᵣₑₛₑₜ and resetting (1025) the receiver of the OLT at the time Tᵣₑₛₑₜ in a next ranging attempt continues until the flow diagram 1000 either determines (1030) that a next ranging attempt is successful or further determines (1035) not to continue changing the time Tᵣₑₛₑₜ. In either instance, a fault condition is identified.

In FIG. 10, the flow diagram 1000 illustrates incrementing (1040) the time to reset a receiver of an OLT (Tᵣₑₛₑₜ) so that in each successive ranging attempt, the receiver is reset (1025) at a later and later time. In an alternative embodiment (not shown), a time to reset a receiver of an OLT is decremented so that in each successive ranging attempt, the receiver is reset at an earlier and earlier time.

It should be understood that elements of the block diagrams, network diagrams, and flow diagrams described above may be implemented in software, hardware, or firmware. In addition, the elements of the block diagrams and flow diagrams described above may be combined or divided in any manner in software, hardware, or firmware. If implemented in software, the software may be written in any language that can support the embodiments disclosed herein. The software may be stored on any form of computer-readable medium, such as RAM, ROM, CD-ROM, and so forth. In operation, a general purpose or application specific processor loads and executes the software in a manner well understood in the art.

Although described in reference to ranging grants and ranging responses, it should be understood that other signals may be used to determine timing between the OLT and ONTs. Further, although the examples are presented herein in reference to optical networks, such as passive optical networks, it should be understood that example embodiments of the present invention can be applied to other networks, such as wireless radio frequency (RF) networks in which timing between two wireless devices can be disrupted by a rogue device.

What is claimed is:

1. A method for ranging an Optical Network Terminal (ONT) comprising:
resetting a receiver of an Optical Line Terminal (OLT) at about a time a ranging signal from an ONT is expected to be received to tolerate a fault condition otherwise affecting ranging of the ONT.

2. The method of claim 1 further comprising:
comparing ranging results of attempting to range the ONT using a standard ranging window and attempting to range the ONT by resetting the receiver of the OLT at about the time the ranging signal from the ONT is expected to be received; and
notifying an operator of a fault condition based on comparing the ranging results.

3. The method of claim 1 wherein resetting the receiver of the OLT at about the time the ranging signal is expected to be received is based on an equalization delay assigned to the ONT previously.

4. The method of claim 1 wherein resetting the receiver of the OLT at about the time the ranging signal is expected to be received is based on a time previously determined by a successful ranging attempt.

5. The method of claim 1 further comprising:
determining whether ranging the ONT is successful; and
changing a time to reset the receiver of the OLT in an event ranging the ONT is unsuccessful.

6. The method of claim 5 further comprising storing the time to reset the receiver of the OLT in an event ranging the ONT is successful.

7. The method of claim 5 wherein changing the time to reset the receiver of the OLT includes adding a delay to the time when the OLT is expected to receive the ranging signal.

8. The method of claim 5 wherein changing the time to reset the receiver of the OLT includes subtracting a delay from the time when the OLT is expected to receive the ranging signal.

9. The method of claim 5 wherein changing the time to reset the receiver of the OLT includes iteratively incrementing a delay over a range of delays to delay the time to reset the receiver of the OLT and to compensate for variations in an equalization delay due to physical conditions expected to be experienced by an Optical Distribution Network (ODN).

10. The method of claim 5 wherein changing the time to reset the receiver of the OLT includes iteratively incrementing a delay by whole number delay increments to delay the time to reset the receiver of the OLT.

11. The method of claim 5 wherein changing the time to reset the receiver of the OLT includes iteratively incrementing a delay by random delay increments to delay the time to reset the receiver of the OLT.

12. The method of claim 5 wherein changing the time to reset the receiver of the OLT includes iteratively incrementing a delay by calculated delay increments to delay the time to reset the receiver of the OLT.

13. The method of claim 5 wherein changing the time to reset the receiver of the OLT includes iteratively incrementing a delay from minus 20 bit-times to plus 20 bit-times before or after the time the ranging signal from the ONT is expected to be received to delay the time to reset the receiver of the OLT.

14. A system for ranging an Optical Network Terminal (ONT) comprising:
a resetting unit configured to reset a receiver of an Optical Line Terminal (OLT) at about a time a ranging signal from an ONT is expected to be received to tolerate a fault condition otherwise affecting ranging of the ONT.

15. The system of claim 14 further comprising:
a comparing unit configured to compare ranging results of attempting to range the ONT using a standard ranging window and attempting to range the ONT by resetting the receiver of the OLT at about the time the ranging signal from the ONT is expected to be received; and
a notification unit configured to notify an operator of the fault condition based on comparing the ranging results.

16. The system of claim 14 wherein the resetting unit is configured to reset the receiver of the OLT at a time based on an equalization delay assigned to the ONT previously.

17. The system of claim 14 wherein the resetting unit is configured to reset a receiver of the OLT at a time based on a time previously determined by a successful ranging attempt.

18. The system of claim 14 further comprising:
a determining unit configured to determine whether ranging the ONT is successful; and
a time delay changing unit configured to change a time to reset the receiver of the OLT in an event ranging the ONT is unsuccessful.

19. The system of claim 18 wherein the time delay changing unit is adapted to add a delay to the time when the OLT is expected to receive the ranging signal.

20. The system of claim 18 wherein the time delay changing unit is adapted to subtract a delay from the time when the OLT is expected to receive the ranging signal.

21. The system of claim 18 wherein the time delay changing unit is adapted to increment a delay in an iterative manner over a range of delays to delay the time to reset the receiver of the OLT and to compensate for variations in an equalization delay due to physical conditions expected to be experienced by an Optical Distribution Network (ODN).

22. A computer program product comprising a computer usable medium embodying computer usable code for ranging an Optical Network Terminal (ONT), the computer program product including computer usable program code, which when executed by a processor, causes the processor to reset a receiver of an Optical Line Terminal (OLT) at about a time a ranging signal from an ONT is expected to be received to tolerate a fault condition otherwise affecting ranging of the ONT.
